(19) United States
(12) Patent Application Publication
(10) Pub. No.: US 2006/0121316 A1
(43) Pub. Date: Jun. 8, 2006

(54) Method of fabricating a magnetic tag

(76) Inventors: George Tiri Tomka, Hampshire (GB); Rhian Jenna Pugh, Hampshire (GB); Daniel Robert Johnson, Hampshire (GB); Jonathan Geoffrey Gore, Hampshire (GB); William Norman Damerell, Hampshire (GB)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/529,719

(22) PCT Filed: Sep. 29, 2003
(86) PCT No.: PCT/GB03/04203

§ 371 Date: Oct. 3, 2005

(30) Foreign Application Priority Data
Oct. 4, 2002 (GB) 0223018.3

(51) Int. Cl. G11B 5/64; B05D 3/04

(52) U.S. Cl. 428/826; 427/127; 427/443.1; 427/304; 428/836

(57) ABSTRACT

A method of fabricating a magnetic tag having a plurality of information bits on its surface where some or all of the information bits are formed by depositing magnetic material onto the surface by means of an electroless deposition reaction.

This invention relates to the field of identification tags and more particularly to information tags that are magnetically encoded with multiple bits of information.

Radio Frequency Identification (RFID) tags are used in a wide variety of industries, such as security and anti-counterfeiting, manufacturing and logistics and transport. With sufficient storage capacity tags can store and therefore be interrogated to provide information on product price, origin and description.

Within the RFID industry there is a particular demand for cheap, chipless, multi-bit passive tags.

One type of multi-bit chipless tag is disclosed in Flying Null's patent applications WO 96/31790 and GB 2312595A (hereinafter referred to as the “Flying Null” tag or “Flying Null” technique). This tag uses materials that have high permeability, low field saturation and a non-linear M/H response, they are termed soft magnetic materials. The materials utilised have a strong sensitivity to a zero field (a “null” field). By an appropriate arrangement of hard and soft magnetic materials information can therefore be read when the sample is passed through a null field.

GB 2312595A describes a method of fabricating such tags. A number of different fabrication methods are disclosed including (i) suspending ferrite material in a liquid medium and printing such material via standard printing techniques onto the tag structure; (ii) transferring ferrite material from a backing ribbon of plastic material onto the tag via a thermal transfer mechanism and (iii) bonding pieces of coding material with adhesive directly to the tag.

The bonding and thermal transfer mechanisms disclosed above are time consuming and are not capable of producing highly defined patterns of magnetic material. The printing mechanism requires that magnetic material be printed directly through the print system. In the case of ink-jet printing the print heads can become clogged if too much material is present in the suspension. Therefore, it may require several “prints” before suitable levels of ferrite material are present on the tag. Other print mechanisms are unlikely to achieve particularly high definition patterns in comparison to ink-jetting.

Another type of multi-bit chipless tag is disclosed in IBM's U.S. Pat. No. 5,729,201 and U.S. Pat. No. 5,831,532 (hereinafter referred to as the “IBM” tag). In this case an array of amorphous wires in conjunction with a magnetic bias field form the basis of the tag. The tag is interrogated by applying a DC field to the tag and measuring the response to an additional oscillatory (AC) field. An advantage of the IBM tag over the Flying Null tag is that the entire tag can be read at once—there is no need to scan along the tag as is the case in Flying Null.

Amorphous wires are however susceptible to changes in their properties on bending. Further, they are difficult to incorporate into packaging.

It is therefore an object of the present invention to provide a method of fabricating a magnetic tag which overcomes or substantially mitigates the above problems.

According to this invention there is provided a method of fabricating a magnetic tag having a multiple number of information bits on its surface which method comprises forming some or all of the information bits by depositing magnetic material onto the surface by means of an electroless deposition reaction.

Electroless deposition (also referred to as “Autocatalytic plating”) is a form of electrode-less (electroless) plating in which a metal is deposited onto a substrate via a chemical reduction process. The advantage of this technology is that an electric current is not required to drive the process and so electrical insulators can be coated.

Processes exist for the electroless deposition of a large number of metals, including a number of soft magnetic materials such as amorphous Co, NiFe and CoFe from a suitable solution bath. Basically, the solutions contain a salt of the metal (or “metals” in the case of the deposition of metal alloys) to be deposited and a suitable reducing agent, e.g. hypophosphite, hydrazine, borane etc.

The use of an electroless deposition reaction means that the magnetic material required for the formation of the information bits of the tag can be formed directly on the tag surface. There is no need to suspend ferrite material in solution prior to printing and since the material is deposited directly onto the tag there is no need to use amorphous wires.

Deposition will only occur if conditions are suitable on the substrate to initiate and then sustain the autocatalytic process. Therefore in cases where the substrate is a plastic or ceramic, for example, additional steps are required to create suitable surface properties. Usually, in such cases the substrate is “sensitised” with a reducing agent, e.g. SnCl₂. Also, the surface may be “activated” with a thin layer of an intermediate catalytic material, e.g. Palladium (itself a candidate metal for autocatalytic deposition), in order to aid the deposition process. Such “deposition promoting materials” are generally referred to in the literature as “sensitisers” and “activators” respectively.

Therefore the method can incorporate the additional step of coating the surface of the tag in a deposition promoting material, said material being chosen to promote the required magnetic material to be deposited from solution onto the tag surface.

Conveniently the deposition promoting material or electroless deposition reagents can be printed via an inkjet printer. Ink jetting allows a pattern with a resolution down to 20 ^{μ}m to be achieved. The deposited material can reach a thickness of up to 40 ^{μ}M.

As described above deposition will only occur if conditions are suitable on the substrate to initiate and then sustain the autocatalytic process. As well as the substrate itself deposition can be affected by the electro-potential of the metal to deposit and the required strength of reducing agent.

The electrochemical series (see Potential values from the electrochemical series in “Handbook of Chemistry and Physics”, Weast, 53^{rd} Edition, 1972-1973) details voltage potentials for various elements and this can be used to determine whether an element can be deposited via an electroless deposition reaction. Generally, elements with a voltage magnitude potential greater than that for Cobalt (potential=−0.28 volts) cannot be deposited without the use of extremely strong reducing agents (which can cause other problems by, for example, reacting with the substrate of choice). Soft magnetic materials, such as Co and NiFe, can therefore more easily be deposited by an electroless reaction than hard magnetic materials, such as NdFeB and SmCo. However, an autocatalytically deposited pattern can conveniently be further coated with a range of metals or compounds by electrodeposition. Therefore, the method of fabrication can include the further step of electro-depositing further magnetic materials onto the tag after the electroless deposition has taken place (Note: for this further step to be viable there need to be continuous electrical paths in the autocatalytically deposited pattern to act as the cathode of an electrolytic bath).

If desired anisotropy can be introduced into the deposited magnetic material by conducting the electroless reaction in the presence of a magnetic biasing field.

Magnetic tags of the Flying Null type described above can easily be constructed by the methods described above.

The “IBM” tag described above basically consists of a number of pieces of soft magnetic material which are biased to varying degrees by hard magnetic material. Such a tag can conveniently be made by depositing the soft magnetic material via the above methods and then adding hard magnetic material by a different process, e.g. by screen printing of an ink loaded with hard magnetic materials; by electrodeposition, or; by direct printing of loaded inks.

In order for such a “IBM” tag to be able to store multiple bits of information each piece of soft magnetic material needs to be biased by a different field. This can be achieved by a number of various techniques such as printing down greater quantities of hard magnetic material in certain areas or alternatively by using a graded hard magnet as the layer beneath the soft magnetic material.

Embodiments of the invention are described by way of example only with reference to the accompanying drawings in which

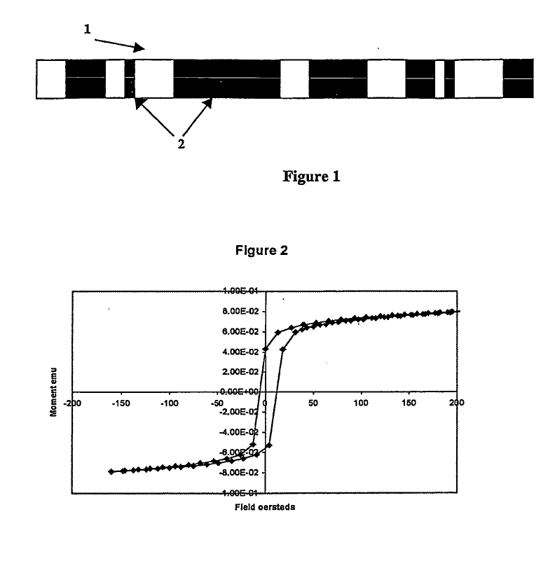

FIG. 1 shows a schematic of a Flying Null Tag.

FIG. 2 shows a BH loop of an electrolessly deposited soft magnetic material in the presence of a magnetic field.

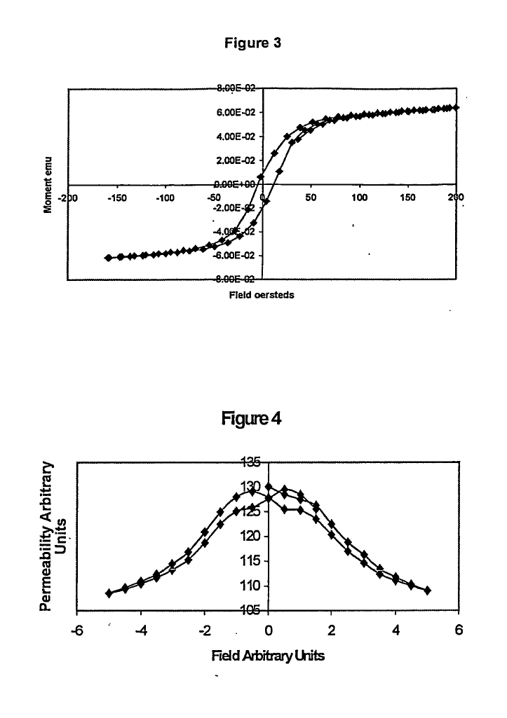

FIG. 3 shows a BH loop of an electrolessly deposited soft magnetic material in the presence of a magnetic field in a different orientation to that shown in FIG. 2.

FIG. 4 shows the characteristic permeability response of an unbiased soft magnetic material element.

FIG. 5 shows the permeability response of the element of FIG. 4 in an bias field.

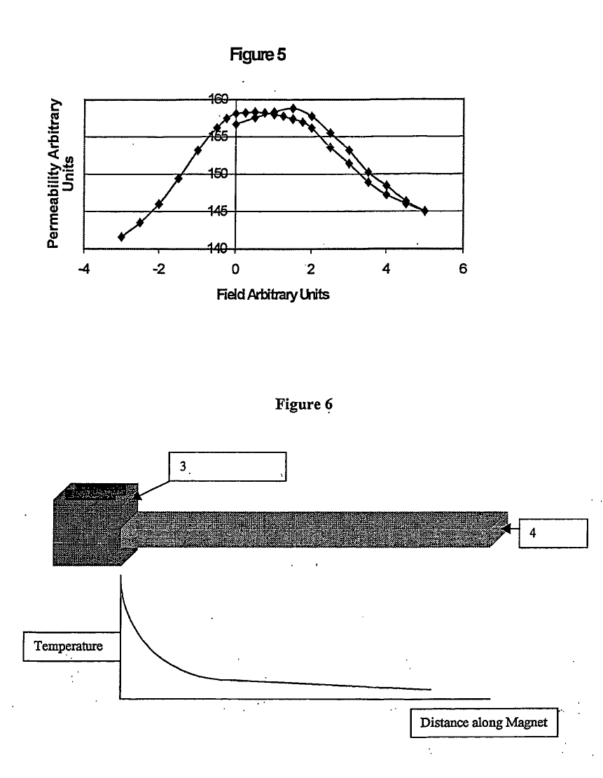

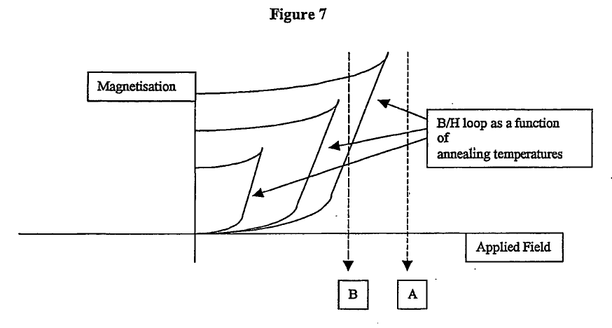

FIG. 6 shows the fabrication of a “graded” hard magnetic material.

FIG. 7 shows BH loops resulting from the different annealing temperatures along the graded magnet shown in FIG. 6.

FIG. 1 shows a typical Flying Null tag. The tag 1 consists of discrete sections of soft magnetic material 2. The separation and size of each section encrypts the information. (It works in a similar way to a conventional bar code, but as opposed to scanning optically, it is scanned magnetically.)

A tag similar to the one depicted in FIG. 1 and consisting of discrete elements of cobalt, a soft magnetic material, was constructed by the above fabrication methods.

Firstly a deposition promoting material, Palladium Chloride, was printed onto the substrate using an inkjet printer in the required form of the tag—discrete elements ˜2 mm square with separations ranging from 1 mm to 10 mm. The separation of the elements encoded the information.

The sensitised substrate was then immersed into an electroless solution bath of a cobalt salt and a dimethylamine borane (DMAB) reducing agent for 10 minutes at a temperature of 50° C. Cobalt metal was deposited onto the promoting material.

In order to introduce anisotropy into the tag the electroless deposition bath was contained within a plastic structure that housed a number of magnets. In this example the magnets used were NdFeB button magnets. The magnetic field stimulated a preferred growth direction in the deposit, and resulted in a magnetic elements with anisotropic properties. FIGS. 2 and 3 show the BH loop of an element of the deposited cobalt in two different orientations. As can be seen the measured BH loop is different in each orientation indicating that the tag has anisotropic properties. The samples were 1 cm² samples, therefore the anisotropy is not due to sample demagnetisation effects.

The substrate was then removed from the bath and allowed to dry.

The tag was read using the standard reading techniques described in the Flying Null patent applications of WO96/31790 and GB2312595A. Opposing magnets provided an area of magnetic null (zero field) and this zero field was then scanned along the length of the tag. This allowed the permeability of the magnetic elements to be read as they passed through the magnetic null.

In this case an alternating interrogation field of 7 kHz was applied through a primary coil. A resulting signal was then picked up in a secondary coil. The resulting signal was a direct measure of the permeability of the sample. As the element moved through the null field it produced a ‘blip’ in the signal, as a result of a rapid change in the permeability of the material at the centre of the null. The second harmonic of permeability was measured.

In another embodiment of the invention a version of the IBM tag was fabricated according to the above described methods.

In a manner similar to the Flying Null tag above, a series of soft magnetic components were printed onto a substrate using an electroless deposition reaction. The magnetic material was once again Cobalt and the components consisted of a number of individual squares of ˜5 mm.

Squares of hard magnetic material were deposited on two opposite sides of the cobalt squares by a screen printing process. The hard magnetic material used was the magnetic ink ‘Nylobag’. The ink had a volume loading of up to 20% magnetic powder (38^{μ}m NdPeB powder). (For volume loadings of greater than 30% it was found that the ink needed diluting in order for it to be screen-printed).

In order to encode information on the “IBM” tag the hard magnetic elements were magnetised to different levels in order to provide a different magnetic bias across each soft magnetic element. This magnetisation was achieved using a pulse field magnetometer. The maximum field pulsed was 20T, and the level of magnetisation was decided by the information to be encoded.

The tag was read by measuring its permeability as a function of an external bias field. The tag was placed in a large solenoid that provided the external bias field. The permeability was then measured through a permeameter. This consisted of a primary coil that provided an alternating field at 7 kHz, and a secondary coil that picked up the signal.

It was found that the bias provided by the hard magnetic materials had shifted the characteristic curves of each soft magnetic element by a set amount and that peaks in the permeability were observed at different external bias fields. The position of these peaks encoded the information contained in the tag.

FIGS. 4 and 5 depict individual elements of the tag. FIG. 4 shows the characteristic permeability response of a soft magnetic element prior to magnetisation of the hard magnetic elements in an externally applied DC field (i.e. an unbiased Co sample printed via the electroless deposition process).

FIG. 5 shows how the characteristic curve shifted as a result of the NdFeB magnetic material which was screen printed at two opposite sides of the Co square. Although not shown each soft magnetic element was biased by varying amounts which enabled information to be encoded onto the tag as described in IBM's U.S. Pat. Nos. 5,729,201/5,831,532.

An alternative approach to biasing the soft magnetic material in the “IBM” type tag is to use a graded hard magnet (i.e. a magnet that has different magnetic properties along its length) as the layer beneath the soft material.

Since magnets can change their properties on annealing a graded magnet can be fabricated by applying different heat treatments to different regions of a magnet.

FIG. 6 shows a heating element 3 at one end of a magnet 4. The heating subjected the magnet to different, decreasing annealing temperatures along its length and therefore correspondingly the final magnet had different magnetic properties along its length, i.e. a graded magnet was formed. It will be appreciated by the skilled man that the annealing temperatures could be more precisely controlled by using discrete heating elements or lasers along the length of the magnet in order to give localised heating up to a certain temperature and to therefore produce a more defined graded magnetic element.

Soft magnetic material was deposited on top of the graded hard magnet by the electroless deposition method described above. In order to encode information onto the tag the graded magnet was taken through a number of different magnetising field histories (see FIG. 6) in order to build up the desired filed profile along its length.

FIG. 6 depicts the “writing” or encoding process for the magnetic tag. The hard/soft magnetic tag was subjected to an external magnetic field. As the field cycles were taken up to a maximum field of A all the graded elements within the hard magnetic substrate pointed in the direction of the external field as they had all been saturated.

An external field of magnitude B, in the opposite direction to field A, was then applied. As a result only the weaker (lower switching-field) graded elements switched direction since there was not sufficient field to switch the stronger element (Elements of the tag with a switching field greater than B remained co-magnetised in the direction of the applied field A). In this way, as this process was repeated, a predetermined field profile was gradually built up in the graded magnetic material. The bias field acting on the soft magnet material depended on the size and the separation of the different co-magnetised graded elements.

The information was encoded in the size and separation of the co-magnetised elements.

The above process (using a graded magnet) is reasonably fast and has the advantage that the whole tag can be magnetised simultaneously. Furthermore the process can allow writing of batches of many tags simultaneously (e.g. within a solenoid) and such tags can be erased and over-written with a different code.

Prior art tags are known to suffer from an orientation problem during the reading phase. For example an “IBM” tag can be read in its entirety in one go but the orientation of the applied DC field with respect to the magnetic field as a result of the applied bias must be known. This enables the prediction of the magnitude of the shift in the characteristic curve of each element. There is therefore disclosed a method of overcoming this orientation problem comprising including within a magnetic tag an information bit that has a known property (e.g. permeability) response to the applied parameter (DC field)—a so-called “orientating bit”.

The tag reader will then be able to scan a vector field in three-dimensional space (for example by using 3 orthogonal pairs of Helmholz coils). As the response of the orientating bit will be known, the reader can then work out the orientation of the whole tag. The response of the tag can then be corrected accordingly to account for any misalignment.

1. A method of fabricating a magnetic tag having a plurality of information bits on its surface which method comprises forming some or all of the information bits by depositing magnetic material onto the surface by means of an electroless deposition reaction.

2. A method as claimed in claim 1 wherein some or all of the tag surface is coated with a deposition promoting material in order to facilitate the deposition of a magnetic material coating from an electroless deposition solution onto the coated areas of the substrate.

3. A method as claimed in claim 2 wherein the deposition promoting material is printed onto the substrate by a print transfer mechanism.

4. A method as claimed in claim 3 wherein the print transfer mechanism is ink-jet printing.

5. A method as claimed in claim 1 wherein the deposited material is a soft magnetic material.

6. A method as claimed in claim 1 wherein the electroless deposition reaction takes place in a magnetic biasing field.

7. A magnetic tag produced by the method of claim 1.

8. A magnetic tag having a plurality of information bits on its surface comprising an arrangement of hard and soft magnetic materials wherein the soft magnetic materials are deposited onto the tag surface by means of an electroless depositon reaction and the hard magnetic materials are deposited by screen printing an ink formulation loaded with hard magnetic materials.

9. A magnetic tag as claimed in claim 8 wherein the deposited hard magnetic material is arranged such that the soft magnetic materials experience a magnetic biasing field.

10. A magnetic tag as claimed in claim 9 wherein the hard magnetic material is deposited such that different information bits formed from soft magnetic materials experience different biasing fields.

11. A magnetic tag having a number of information bits on its surface comprising an arrangement of hard and soft magnetic materials wherein the soft magnetic materials are deposited onto the tag surface by means of an electroless deposition reaction and a graded hard magnetic material is used as the whole of or part of the substrate of the tag.
